(19) United States
(12) Patent Application Publication
(10) Pub. No.: US 2005/0198160 A1
(43) Pub. Date: Sep. 8, 2005

(54) System and Method for Finding and Using Styles in Electronic Communications

(75) Inventors: Marvin Shannon, Pasadena, CA (US); Wesley Boudville, Perth (AU)

Correspondence Address: MARVIN SHANNON, 3579 EAST FOOTHILL BLVD, #328, PASADENA, CA, 91107, US

(73) Assignees: Marvin Shannon, Pasadena, CA (US); Wesley Boudville, Perth (AU)

(21) Appl. No.: 10/906,742

(22) Filed: Mar. 3, 2005

Related U.S. Application Data
(60) Provisional application No. 60/521,174, filed on Mar. 3, 2004.

(51) Int. Cl. G06F 15/16

(52) U.S. Cl. 709/206

(57) ABSTRACT

We describe what we mean by styles, and show how these can be extracted from electronic messages. We describe the special and important case of email. We show how styles can be used to detect possible spam in a group of messages. We give details of many styles. These are independent of any particular human language in which an electronic message might be written. We show how the use of Bulk Message Envelopes leads to effective styles. We show one usage in distinguishing between newsletters and non-newsletters in bulk messages. Social networks can also be made, with useful marketing and other commercial applications. Styles can also be made to characterize correlations between messages in different electronic communication spaces, like email, SMS, Instant Messaging, Web pages, and Web Services.

### CROSS REFERENCE TO RELATED APPLICATIONS

This application claims the benefit of the filing date of U.S. Provisional Application No. 60/521174, “Systems and Method for Finding and Using Styles in Electronic Communications”, filed Mar. 3, 2004, and U.S. Provisional Application No. 60/481745, “System and Method for the Algorithmic Categorization and Grouping of Electronic Communications”, filed Dec. 5, 2003, and U.S. Provisional Application No. 60/481789, “System and Method for the Algorithmic Disposition of Electronic Communications”, filed Dec. 14, 2003, and U.S. Provisional Application No. 60/481899, “Systems and Method for Advanced Statistical Categorization of Electronic Communications”, filed Jan. 15, 2004, and U.S. Provisional Application No. 60/521014, “Systems and Method for the Correlations of Electronic Communications”, filed Feb. 5, 2004. Each of these applications is incorporated by reference in its entirety.

### SUMMARY OF INVENTION

The foregoing has outlined some of the more pertinent objects and features of the present invention. These objects and features should be construed to be merely illustrative of some of the more prominent features and applications of the invention. Other beneficial results can be achieved by using the disclosed invention in a different manner or changing the invention as will be described. Thus, other objects and a fuller understanding of the invention may be had by referring to the following detailed description of the Preferred Embodiment.

The present invention is directed at finding certain characteristic properties of bulk electronic messages. We term these properties ‘styles’. These can be used to categorize such messages as bulk or spam. Some styles can be computed from single instances of a message. But we define several styles that use the Bulk Message Envelope (BME) that we construct from receiving multiple copies of a message. Where typically the sender (spammer) performs operations on the original base message, in order to produce apparently unique messages. This is done to evade many simple antispam methods. Our invention includes the programmatic computation of various BME styles, and the use of these to strongly label messages as bulk or as spam.

We extend this into the computation of styles that arise out of correlating messages in different electronic communication modalities. This aids in the classification of messages in each such modality.

### DETAILED DESCRIPTION

### DESCRIPTION

### TECHNICAL FIELD

This invention relates generally to information delivery and management in a computer network. More particularly, the invention relates to techniques for automatically classifying electronic communications as bulk versus non-bulk and categorizing the same.

### SUMMARY OF THE INVENTION

The foregoing has outlined some of the more pertinent objects and features of the present invention. These objects and features should be construed to be merely illustrative of some of the more prominent features and applications of the invention. Other beneficial results can be achieved by using the disclosed invention in a different manner or changing the invention as will be described. Thus, other objects and a fuller understanding of the invention may be had by referring to the following detailed description of the Preferred Embodiment.

The present invention is directed at finding certain characteristic properties of bulk electronic messages. We term these properties ‘styles’. These can be used to categorize such messages as bulk or spam. Some styles can be computed from single instances of a message. But we define several styles that use the Bulk Message Envelope (BME) that we construct from receiving multiple copies of a message. Where typically the sender (spammer) performs operations on the original base message, in order to produce apparently unique messages. This is done to evade many simple antispam methods. Our invention includes the programmatic computation of various BME styles, and the use of these to strongly label messages as bulk or as spam.

We extend this into the computation of styles that arise out of correlating messages in different electronic communication modalities. This aids in the classification of messages in each such modality.

### DETAILED DESCRIPTION OF THE PREFERRED EMBODIMENT

What we claim as new and desire to secure by Letters Patent is set forth in the following claims.

In an earlier provisional patent, we have described a programmatic and objective way of identifying bulk electronic messages. (U.S. Provisional Patent No. 60320046, “System and Method for the Classification of Electronic Communications”, filed Mar. 24, 2003.) Specifically, this method can be used in email to help detect email spam.

In what follows, we refer to the specific case of email, for the ease of illustration and because of the economic importance of email. But our methods are applicable, with suitable qualifications that we will describe below, to any electronic communication, including, but not limited to, Instant Messaging (IM) and IM-like communications, Short Message Systems (SMS), junk faxes and cellphones. In ['0046], we described how we could apply various deterministic rules against a message, but ['0046] did not define those rules. Here, we do that. We call these rules “styles”. The rules try to detect whether certain properties are present in the message. Typically, most of these styles are used by spammers to evade various deployed antispam techniques. Hence, if a message has a given style, that can make it more likely that it is spam. Plus, if a message has several styles, it might be even more likely to be spam.

In this Application, we describe in detail many useful styles. The styles are divided into two groups. The first group is those that are applied against single messages. We will later make methods involving the usage of these in conjunction with our other methods.

The second group of styles are those that are based on our method in ['0046] of performing canonical reduction of a message before making hashes, and on the extraction of link domains from the body of a message.

The present invention comprises that styles can be defined in any electronic communication modality.

The present invention comprises that styles can be applied to messages written in any human language.

The present invention comprises that styles can be found by a message provider, like an Internet Service Provider, or any organization, that sends and receives electronic messages to its users.

The present invention comprises that styles can be found by a group of users who send and receive electronic messages, both within the group and to and from outside users, where the group is defined in a peer-to-peer fashion.

The present invention comprises that styles can be found from incoming messages, and from outgoing messages, or both.

The present invention comprises that styles can be associated with any of: a message, a set of messages, a Bulk Message Envelope (BME) ['0046, '1745], a set of BMEs, a cluster ['1745], a set of clusters, a domain, a set of domains, a relay, a set of relays, a hash, a set of hashes, a user, a set of users, or any combination of these.

Note that a cluster is a special type of a set of BMEs. But it is important enough that we include it explicitly in the previous list.

The present invention comprises that where below we say ‘hashing’, other types of summary characterizations of digital data, like checksums, may be used instead. Though possibly this may be of lesser efficacy.

2. Message Styles

- - -

Many are listed here. Optionally, there could be more. These are applied against single messages.

1. Base64 Encoded.

Some messages have the body encoded in this way. A browser can detect this and automatically decodes it. The user is typically unaware that the message was ever encoded in this way. Some spammers use this to elude elementary antispam techniques that do not decode base64 data.

One possible non-spam reason for using base64 encoding is if the message contains some characters that some mailers might have trouble handling. Base64 output is strictly ascii, so any mailer can cope with this. But because of this reason, the presence of a base64 encoded message is suggestive of spam, and not conclusive.

2. From Line Missing.

Some spammers decide that instead of forging a From line, to just leave it blank. Most regular non-spam messages are written and sent using message software that automatically inserts a From value for the sender. Its absence suggests that something active was done to make it so. In practice, most spammers will not do this, but instead write a false entry.

3. HTML Message has ‘Small’ Images.

These images are sometimes called thumbnails. Some spammers use these to detect when someone has opened one of their messages. The HTML <img> tag loads a source file from the spammer's domain. But the load instruction can also contain information about the electronic address of the user. Hence the spammer can find out two important things, even if the user never clicks on anything in the message. First, the spammer confirms that the address is valid. Second, that it is active. Which raises the value of the address to the spammer for future use, including resale.

A image that is loaded in this way is typically only 1 pixel by 1 pixel. It might be the same color as the background. So often the user is unaware that such an image even exists.

The problem is that some major message providers also use thumbnails, for other reasons. So the presence of a thumbnail, in the absence of any other styles, is only suggestive of spam.

4. HTML Message has Only Images.

Some spammers construct messages in this way. Caution is required, because, for example, a user might sent messages just containing photos to her friends, where her friends might already be expecting these, and hence she puts no textual annotation with the images. So this style is suggestive of spam, but not conclusive.

5. Invisible Text.

This arises in HTML messages. A string is written with its foreground color equal to the background color. Hence when displayed, the user cannot see it. Though if she is using a browser, and she drags her mouse across the area where the text is drawn, it can be highlighted. In spam, it can be used to write unique random text in each copy of a message, that the user cannot see. This is used to defeat techniques that compare one message with another for matching.

The presence of invisible text is strongly suggestive of spam. There is little other reason for it to be present.

6. Almost Invisible Text.

This arises in HTML messages. A string is written in a foreground color that is very close to the background color. Subtler than writing invisible text, because the presence of the latter may well be taken as indicating spam. Here, the question is how to define ‘almost’.

One possibility is to define a maximum distance between the foreground color of a string and its background color, below which we consider it to be “almost invisible”. An antispam method should have some means of letting a message provider's system administrator set this. This leads to a binary result, 0 if no text is almost invisible, and 1 is some text is almost invisible.

An alternative method might be to define some metric d(foreground,background) for the distance between the two colors, scaled to [0,1]. Then use the result 1-d, which is now in the range [0,1], instead of being a binary result.

The presence of almost invisible text is possibly suggestive of spam.

7. Leading Zeros in Numerical Entities.

A numerical entity is something like ‘&#65;’which stands for ‘A’. Most browsers will disregard several leading zeros, so that, for example, ‘&#00065;’ and ‘&#0065;’ and ‘&#065;’ and ‘&#65;’ will all be shown as ‘A’. So a spammer can create unique copies of a message, to foil simple exact comparisons of messages.

So unnecessary leading zeros are highly indicative of spam.

8. Misleading Visible URL.

For example, suppose we have <a href=“http://aspammer.com/di3”>http://good.com</a>. The visible part seen by the reader is http://good.com. But the link actually goes to aspammer.com. While the reader can see this, by either viewing the full text of the message, or by moving the mouse over the link and seeing at the bottom of the browser where the link goes, many might not notice. Phishing messages often do this. (See below.)

Note that we do not consider the visible URL to be misleading when its domain is the same as the domain in the actual link, even if the two URLs are different. For example, consider this, <a href=“http://all.good.com/bin/test?ci=33”>http://good.com</a>. The base domain (good.com) is the same. There is valid reason here to make the two URLs different. The visible URL may be a simpler form of the actual link, to suppress unnecessary detail, that the reader can safely ignore.

9. Numerical Entities for Printable Characters.

Consider the earlier example of ‘&#65;’, which stands for ‘A’. There is no need to use the former in a message, when the latter is perfectly adequate. So a spammer can take text that is to be seen by the reader, and replace various letters by their numerical entity equivalents. This can be used to make unique copies of a message.

Very indicative of spam.

10. Numerical Entities in Decimal and Hex.

Consider the earlier example of ‘&#65;’ which stands for ‘A’. The 65 is in base 10. The entity could also have been written as ‘&#×41;’ which also means ‘A’. The 41 is in base 16. This is another way that a spammer can generate unique messages. So if a message were to contain numerical entities, for whatever reason, why should some be in decimal and others in hex? The presence of both in the same message is very indicative of spam.

11. Phishing?

Various tests have been tried to detect these messages. Typically, a message purports to be from a financial institution, according to the visible text in the message, usually accompanied by images that are downloaded from the institution's web site, if these images are accessible to anyone on the web. But the catch is that the user is asked to fill out a form, with sensitive information about the user, and then to submit this form. But the data actually goes to a third party site, where it is harvested by the scammer.

One way to attempt to detect phishing involves making a list of large companies and companies with a large presence on the web. The latter might include eBay, PayPal, and Amazon. Then given an HTML message, we can check for the following, if a <form> is present.

a. The domain in the form's action is present nowhere else in the message.

b. The domain is not in the above list of companies.

c. There are links elsewhere in the message to a company in the list.

d. The sender's domain is the same as that of the company in the previous item.

12. Random Comments in HTML.

Some spammers put HTML comments, whose contents are random characters. These can be detected through various known techniques. The biggest problem in doing so is the computational cost.

13. Raw Internet Protocol Addresses.

In links, some spammers might use these, instead of domain names, for deliberate obscurity. But non-spam that has links may sometimes also do this. Slightly indicative of spam.

14. Bad Relay Information.

Spammers can often modify most header information. They might alter the relay information to conceal the origin of the spam. Sometimes, they write invalid Internet Protocol addresses, or addresses of relays that are known to the receiving message server to be associated with spam.

15. Secure Protocols.

This refers to whether a link uses a secure protocol, https, sftp, ftps, ssh. It is different from the other styles, where the presence of one of those is at least suggestive of a negative datum about a message. The presence of a secure protocol is not necessarily a bad thing. In some cases, it might be desirable.

16. Subject Line Starts with ‘ADV:’.

This may be taken to be spam. Some of the more respectable spammers write this in the subject line, in part to conform with a California regulation. But most spammers do not bother. Still, a few percent of bulk message often has this, and it is simple to check, so it is worth doing.

17. URLs have Hexes Instead of Chars.

In a URL, a character can be represented by its hexadecimal equivalent. For example, ‘w’ can be written as ‘%77’, where 77 is hex for the ascii representation of ‘w’. Spammers can use this to either generate unique messages, or to obscure where a link is pointing to. Because seeing ‘%77’ in an URL is far less meaningful to most readers than ‘w’, for example.

18. Unknown HTML Attributes.

In an HTML tag, a spammer can write an attribute that does not actually exist for that tag. A browser seeing this will ignore it, for forward compatibility. Hence it does not affect what the user sees. But the spammer can use this to introduce uniqueness into messages. Very indicative of spam.

19. Unknown HTML Tags.

In an HTML message, a spammer can write a tag that is not actual HTML. Most browsers will ignore this, for forward compatibility. Hence it does not affect what the user sees. But the spammer can use this to introduce uniqueness into messages. Very indicative of spam.

20. Variable Attribute Order in HTML.

In a given HTML tag, if it has two or more attributes, these can be written in any order. The display is unaffected in most browsers. So if there are n attributes, a spammer can generate n! variants of the tag by this means. In a given message, suppose a particular type of tag appears several times. If it has the same attributes in two or more instances, and the order of these varies, then this style is present.

Possibly indicative of spam.

21. Variable Quotes in HTML Tags.

In an HTML tag, we can set the value of an attribute by either, e.g., a=‘14’ or a=“14”, or by not using quotes at all, if there is no whitespace in the value. But where quotes are used, these can be single or double. If a message has some cases of using single quotes and others of using double quotes, then this style is present.

22. Variable Upper and Lower Cases in HTML Tags.

In the name of an HTML tag, any combination of upper and lower cases is possible. For example, these are all the same to a browser: <body>, <BODY>, <bODy>. Another way for a spammer to introduce uniqueness. If a message has variable cases, then this style is present.

23. Varying Whitespace in HTML Tags.

Inside an HTML tag, we can have any amount of whitespace between attributes and between the name and the first attribute, if there are any attributes. The browser displays the same thing, regardless of the amount of whitespace. So we can measure the amount of whitespace and see if it varies.

3. Styles Specific to Our Method

- - -

Most of these styles rely on the use of a Bulk Message Envelope (BME). ['0046, '1745] This is an important difference between these and the Message Styles, which are all applied against single messages. In the making of a BME, we have invented the styles described in this section.

Below, where we discuss fractions of various items, this is just for convenience in normalizing the output to be in the range [0,1]. There is no significant difference between this and, say, counting the various items.

The present invention comprises each of these styles.

1. Canonical Body Empty.

After performing the canonical steps in ['0046] on a message, sometimes this happens. Suggestive of spam, because the steps removed possible places where a spammer could introduce spurious variability. Typically, non-spam messages have enough “real” material that something remains after the canonical steps. (This style does not use a BME.)

2. Message Copies have More than 1 from Line.

It is well known that spammers often forge the subject line of their messages. Despite this, some antispam techniques still block against the sender line of messages deemed, by whatever means, to be spam. However, we have found a way to use the sender line, and the very fact that it can be forged, as a strong indicator of spam. This style refers to the use of the canonical steps and hashing on a set of messages. Then, the message hashes are compared across messages. If two messages are canonically identical, that is, they have the same hashes, then they are part of the same BME, and we look at the From lines. If these are different, it is highly suggestive of spam.

It is difficult for spammers to counteract this. If a spammer uses only one false sender address per set of copies of a message, then other existing antispam techniques may detect and block against that particular address, false though it may be. Which is why spammers often generate a set of false addresses. But if we detect this style, it is virtually conclusive of spam.

3. Message Copies have more than one Subject Line.

In a similar way to the previous style, it is well known that spammers often generate different subject lines, for a set of copies of a given message. Other antispam techniques often devote what is futile attention towards parsing the subject line of messages.

This style refers to the use of the canonical steps and hashing on a set of messages. Then, the message hashes are compared across messages. If two messages are canonically identical, that is, they have the same hashes, then they are part of the same BME, and we look at the Subject lines. If these are different, it is highly suggestive of spam. After all, why should two identical messages have the same subject line?

Note that all we need check for is that the Subject lines are different. We do not care what language these are written in. This is one advantage.

Another advantage is that we do not need to keep a list of words that might indicate spam, like “free” or “Easy Credit”, to try to find in a Subject line. Quite apart from the fact that these are in one language, English, it is well known that spammers who want to put these in the Subject line can vary the spellings heavily.

Another advantage is that we do not need to somehow infer if the “meaning” of a line is different from that of the actual body. This is vastly easier than some antispam techniques that attempt to see if a Subject line is “misleading”.

4. Message Copies have Different Link Domains.

Our method of canonical reduction and hashing helps us find templates of spam. In making a BME out of a message, if we find another message whose hashes are the same, then we compare the link domains that we have extracted from both messages. If there are different link domains, it is highly suggestive of spam, and specifically of template spam. That is, the original message may have been constructed with blank link entries, as a template. Then it may have been sold to other spammers, each of whom inserted her own domains into her copy. (And then presumably made many thousands of instances of it.)

5. Too Many Relays in a BME.

When we made a BME from a message, and then found another message with the same hashes, we also compare the relay paths. Each message can have a list of relays, that indicates the path it took. But these entries could be forged by a spammer to hide her origin, in the same way that she might forge the sender line. Here, if we find that a relay path is different from any of those already in the BME, we add it to the BME. Plus, we check against a setting which is a maximum number of relay paths per BME. If the total number of paths is greater than this number, we set this style. That maximum number can be changed by each message server's administrator. The reasoning behind recording this style is analogous to that for the previous styles. Here, suppose we have multiple copies of a message being sent out. If they came from the same location, then their paths should often be the same. It is possible that occasionally the paths might be different. That is inherent in the Internet Protocol, because a relay might go down for some time, during which a copy of a message might then travel via a different path than an earlier copy.

Notice that here, this style does not care if the relay information is true or false. Suppose all the relay information is true. That means that we have seen canonically identical messages arrive from different parts of the net. What are the chances of truly independently written identical messages doing so? Very indicative of spam, where we have several spammers at different locations. Now suppose all the relay information is false. Why should canonically identical messages arrive via many different paths? It suggests that the information is false, which we infer as in turn suggesting that the messages are spam. We are assuming that senders of non-spam will not forge headers.

Consider the styles 2-5 in the previous list. Bulk messages contain mostly spam. But a significant subset of bulk is newsletters. These may be noncommercial or commercial. One significant problem that many antispam techniques have is distinguishing between newsletters and spam. It is not sufficient to say that by manual inspection, one could tell the difference. This may well be true. But given the volume of messages, it is desirable to find a programmatic means of doing so. We offer a method. We suggest that most real newsletters do not forge their headers. So they do not forge their From lines and the relay information. Plus, when they send out copies of a message, the subject line is the same. Therefore, we have the following.

The present invention comprises the use of styles 2-5 in the previous list in distinguishing between newsletters and non-newsletters (mostly spam) in bulk messages.

The present invention comprises of these other styles, as applied to a BME or an arbitrary set of BMEs.

1. Fraction of a BME's domains, or a set of BMEs' domains, that are in a Real time Black List (RBL).

Here, the RBL could be obtained from an external data source, like Spamhaus.org. Or it might be derived from current or historical data available to us.

2. Fraction of a BME's relays, or a set of BMEs' relays that are in an RBL.

See the comments from the previous item. Here, the RBL could be for domains in general. Or it might be an RBL of specifically suspect bad relays.

3. Fraction of a BME's domains, or a set of BMEs' domains, that are in a table of suspected link farms. A spammer may search for extra revenue by running a link farm. This table may be generated by us or by some external entity that we regard as reliable in this respect.

4. Fraction of a BME's domains, or a set of BMEs' domains, that have no home pages.

If a domain is, say, aspam.com, then we look for a home page at either aspam.com or www.aspam.com. Even most spammers will probably have home pages. But a lack of a home page may be considered significant. It may indicate fraudulent spam.

5. Fraction of a BME's users, or a set of BMEs' users, that have complained about it.

Here, by users, we mean the recipients of the BME.

6. Fraction of a BME's hashes, or a set of BMEs' hashes, that are in a table of known bulk message hashes.

The table might be considered as an RBL of hashes. The table could be obtained from an external data source, or derived from current or historical data available to us.

7. Fraction of a BME's users, or a set of BMEs' users, that are probe accounts, where these accounts actually exist.

This can be used to see how a spammer is harvesting addresses.

8. Fraction of a BME's users, or a set of BMEs' users, that are nonexistent accounts, and which have never existed.

This can be used to see if a spammer is using a dictionary attack to guess addresses. For example, suppose we are running adomain.com and that there has never been a username of ‘dave’, which is general is a common username. If we see spam arriving for dave@adomain.com, and where we have never posted that address on the web, then it suggests a dictionary attack.

9. Fraction of a BME's users, or a set of BMEs' users, whose addresses can be found on search engines. The idea is to get some indication of how a spammer might be finding addresses. We do not suggest that the spammer is using a search engine. Rather, if a search engine finds web pages with some users' addresses, it suggests that these pages may be targeted by a spammer's spider.

10. Fraction of a BME's domains, or a set of BMEs' domains, with nearest neighbors in Internet Protocol space that are in an RBL.

11. Fraction of a BME's domains, or a set of BMEs' domains, with nearest neighbors in Internet Protocol space that are in a table of suspected link farms.

A very important case of a set of BMEs is a cluster, of any type, that can be derived using our methods in ['1745], starting from a set of BMEs. Hence the present invention comprises these styles.
1. Fraction of a cluster's domains that are in an RBL.
2. Fraction of a cluster's relays that are in an RBL.
3. Fraction of a cluster's domains that are in a table of suspected link farms.
4. Fraction of a cluster's domains that have no home pages.
5. Fraction of a cluster's users that have complained about it.
6. Fraction of a cluster's hashes that are in a table of known bulk message hashes.
7. Fraction of a cluster's users that are probe accounts, where these accounts actually exist.
8. Fraction of a cluster's users that are nonexistent accounts, and which have never existed.
9. Fraction of a cluster's users whose addresses can be found on search engines.
10. Fraction of a cluster's domains with nearest neighbors in Internet Protocol space that are in an RBL.
11. Fraction of a cluster's domains with nearest neighbors in Internet Protocol space that are in a table of suspected link farms.

The present invention comprises the method of finding for a cluster, the nexii, where each nexus splits the cluster into two disjoint graphs, if it is removed.

In analyzing clusters, especially large clusters, finding nexii is useful, because these can be the key nodes, and because removing one or more to decompose a cluster can let us recursively break down a cluster into manageable regions for further analysis.

3.1 Domain Styles

- - -

For the case of a domain, the present invention comprises these styles.

1. Is the domain in an RBL?

2. Is the domain in a table of suspected link farms?

3. No home page for the domain?

4. Number of its users that have complained about it.

By a domain's users, we mean the recipients of BMEs, where the BMEs have this domain.

5. Number of its hashes that are in a table of known bulk message hashes. By a domain's hashes, we mean the hashes in BMEs with this domain.

6. Fraction of a domain's users that are probe accounts, where these accounts actually exist.

7. Fraction of a domain's users that are nonexistent accounts, and which have never existed.

8. Fraction of a domain's users whose addresses can be found on search engines.

9. Number of the domain's nearest neighbors in Internet Protocol space that are in an RBL.

10. Number of the domain's nearest neighbors in Internet Protocol space that are in a table of suspected link farms.

3.2 Sender Styles

- - -

Suppose now we look at outgoing messages, sent by our users. Here, we call them senders. We assume that the senders are unable to forge the header information. We can also apply our canonical steps to make BMEs, just as we do for incoming messages.

The present invention comprises these styles.
1. Find fraction of a sender's domains in her messages that are in an RBL.
2. Find fraction of a sender's domains in her messages that are in a table of suspected link farms.
3. Find fraction of a sender's domains in her messages that have no home pages.
4. Find fraction of a sender's recipients that complain about the sender.
5. Find fraction of a sender's hashes in her messages that are in a table of known bulk message hashes.
6. Find average Message Styles for a sender from her messages.
7. Find fraction of a sender's domains in her messages with nearest neighbors in Internet Protocol space that are in an RBL.
8. Find fraction of a sender's domains in her messages with nearest neighbors in Internet Protocol space that are in a table of suspected link farms.

In passing, we explain explicitly this detail about item 1 above. Suppose an RBL has a domain, aspammer.com. If a user Latifa writes a message containing this string, “Hey, I heard that aspammer.com is cool!”, our method does not extract “aspammer.com” from her message and then possibly mark the message as “bad” because the domain is in the RBL. Typically, the recipient of her message will not be able to click on that domain, in most types of viewing software, like a browser. But, if Latifa were instead to write “Hey, I heard that http://aspammer.com is cool!” or “Hey, I heard that <a href=‘http://aspammer.com’>aspammer.com</a>is cool!’, then our method would extract “aspammer.com”, because most viewing software will write those two examples as clickable links. This is a deliberate feature of our method. As another way to attack spam, it discourages non-spammers from writing clickable links to spammer domains.

Item 4 also deserves some comment. It is different from the common ability of a recipient of an unwanted message from, say, anita@adomain.com, to reply to, e.g., root@adomain.com, complaining about anita and enclosing the unwanted message. In this example, we are running adomain.com and we get this message. If anita sends out messages that are different from each other, but actually canonically identical, under ['0046], then just as we can build a BME, here we can aggregate complaints that are actually about some canonically identical message.

The above styles can be computed over some time period. Which leads to us to have these styles, for comparing a sender's current behavior to her past behavior.
1. Find a sender's domains that are in an RBL, over some long time period and over a recent time period, and compare these for deviations.
2. Find a sender's domains that are in a table of suspected link farms, over some long time period and over a recent time period, and compare these for deviations.
3. Find a sender's domains that have no home pages, over some long time period and over a recent time period, and compare these for deviations.
4. Find a sender's recipients that complain about the sender, over some long time period and over a recent time period, and compare these for deviations.
5. Find a sender's hashes that are in a table of known bulk message hashes, over some long time period and over a recent time period, and compare these for deviations.
6. Find average Message Styles for a sender from her messages, over some long time period and over a recent time period, and compare these for deviations.
7. Find a sender's domains with nearest neighbors in Internet Protocol space that are in an RBL, over some long time period and over a recent time period, and compare these for deviations.
8. Find a sender's domains with nearest neighbors in Internet Protocol space that are in a table of suspected link farms, over some long time period and over a recent time period, and compare these for deviations.

The present invention comprises these styles, for comparing a sender to other senders.
1. For all senders, find a sender's domains that are in an RBL, over some time period, and compare these for deviations.
2. For all senders, find a sender's domains that are in a table of suspected link farms, over some time period, and compare these for deviations.
3. For all senders, find a sender's domains that have no home pages, over some time period, and compare these for deviations.
4. For all senders, find a sender's recipients that complain about the sender, over some time period, and compare these for deviations.
5. For all senders, find a sender's hashes that are in a table of known bulk message hashes, over some time period, and compare these for deviations.
6. For all senders, find average Message Styles for a sender from her messages, over some time period, and compare these for deviations.
7. For all senders, find a sender's domains with nearest neighbors in Internet Protocol space that are in an RBL, over some time period, and compare these for deviations.
8. For all senders, find a sender's domains with nearest neighbors in Internet Protocol space that are in a table of suspected link farms, over some time period, and compare these for deviations.

The utility of the sender-specific styles is that we can programatically watch to see if a sender's behavior, as measured by the outgoing messages, changes compared to her past history, or if it is quite different from that of other users. It can be used to detect if, for example, someone has found a user's password and is then using her account to issue spam. Or, for a new user, who has no past history, it can be used to detect if she turns out to be a spammer. This goes far beyond doing a simplistic count of how many messages a sender produces.

3.3 Time-Based Styles

- - -

A BME can also store the times in the relay header information. But in general, only the arrival times when messages are received by us can be considered reliable. Relay times can be forged by spammers.

The present invention comprises the finding of the fraction of a BME's messages, or of a set of BMEs' messages, with relay times that are before the arrival times minus some maximum transit time.

This maximum transit time is chosen by us. It can be a function of the communications protocol. For example, with the Internet Protocol, we might chose a time of 4 days, reckoning that it is unlikely that any message would take so long to reach us.

There might also be messages offering goods or services in a given time interval. (“48 Hour Thanksgiving Sale. Hurry!!”) Thus the following method. In this, we mention sending times, as well as arrival times. The former can cover the case where we are a message provider with users sending out messages and we make BMEs from outgoing messages.

The present invention comprises the finding of the fraction of a BME's messages, or of a set of BMEs' messages, with sending or arrival times that are in some given time interval.

3.4 Geographic Styles

- - -

Here we describe various styles using BMEs in a geographic context. Below, when we mention a user or users in a method, it is assumed that the user or users have associated BMEs.

The present invention comprises the method of deriving the number and list of countries or locations from the domains in a BME, a set of BMEs (specifically including any cluster derivable from a set of BMEs), a user, or a set of users. In the latter two cases, this can be for incoming or outgoing messages or both.

The method is this. Given a BME or any of the other cases in the previous method, we can extract a list of domains that are pointed to. (If there are no domains in the original messages, then of course this list is empty, and the method ends here.) We use publicly available registration information for those domains to find the network providers hosting them. Then, other public information gives us the geographic location of those network providers, and hence the countries they are in.

Why might this be useful? A spammer might want to locate her domains outside the country that she is sending messages to. Hence, here it is the countries that is significant, rather than the actual distances between those network providers.

But in other circumstances, actual geographic locations might be useful. So in the above method we allow for this, where there might be some distance threshold chosen, so that two locations within this distance only count as one location.

In the above cases, when we described finding geographic data from a user or set of users, the method was to look at the associated BMEs, and thence from the domains in those, extract the geographic data. But there is another way to extract geographic data from a user or set of users. It is via the geographic locations of the users' message providers. If the steps in ['0046] are done by an ISP or company, say, for its users, then there is only one location, and the utility is limited. But suppose that we have a p2p group of users, where the users are scattered over different message providers. Then this information may be useful.

For example, suppose several users have addresses at ucla.edu, ucsd.edu, ucsf.edu and oxford.ac.uk. Of course, a user with, say, johndoe@ucla.edu can be anywhere in the world. But most UCLA users are, in fact, on or around the UCLA campus. Similarly, we can expect that most ucsf.edu users are in or near San Francisco. Then, if a BME is observed by the p2p group going mostly to users at ucla.edu and ucsd.edu, it might appear to be geographically targeted at southern California. Perhaps the BME is advertising something, like an event, that is located in that region? One might ask, if so, why don't we just read one of the messages in the BME. The point here is to find such information programmatically, without manual intervention. The latter should be possible, but only in exceptional cases, otherwise the sheer volume of spam will invalidate manual steps.

Of course, it is also possible in this example, that the spammer, for whatever reason, only managed to collect addresses in southern California, and that the spam has no intrinsic geographic constraint. But the example shows how we can programmatically find extra information that might be useful. Accordingly, we have the following.

The present invention comprises the method of deriving the number and list of countries or locations from a BME, or a set of BMEs (specifically including any cluster derivable from a set of BMEs), or a user, or a set of users; based on the locations of the users' message providers.

Earlier, we discussed the style “too many relays in a BME”. There is a similar idea where we look at the starting relays in the various relay paths in a BME. We can find the geographic locations of these starting relays, and thus the distances between them. If some of these exceed some threshold, the present invention comprises this as “relays are too far apart in a BME”. Because if copies of a message originate at one physical location, it is unlikely that they go to starting relays that are widely separated.

The present invention comprises the method of dividing a set of BMEs or a set of users, into two or more subsets for further analysis, via some geographic criteria that can be applied to the BMEs.

For example, suppose we have a set of BMEs. From these, we make a subset, call it “UK”, for all those BMEs with domains inside the UK. Or, we can make a subset, call it “FR” for all those BMEs with domains inside France. Clearly, it is possible for “UK” and “FR” to have common elements. If so, we can imagine drawing a graph with two nodes, UK and FR connected to each other. With the common edge, we can associate those BMEs with domains in both France and the UK. This is another space in which to make a cluster, akin to the methods described in ['1745]. So we have the following.

The present invention comprises the method of starting with a set of BMEs or users, and constructing clusters, based on geographic criteria.

There is another possible source of geographic information in a BME. It is technically possible to also store geographic information about where the user is, when she received a message, if such information exists. For example, consider a cellphone. Many made after 2001 have GPS capability. It is plausible that the cellphone could record in its memory where it is, to within the accuracy of the location method, for messages that it receives. Or perhaps that the cellphone provider does so. Various other communications methods, like WiFi and Bluetooth, also permit some location sensing.

The geographic data might also exist in other forms. For example, if we know the physical addresses of the users, because they gave this information when they joined our message provider.

For example, a shop might broadcast offers on a WiFi net to all passersby within the range of the net. Also, these offers might be made only during a certain time period, like, say, the week before Thanksgiving. So we can combine looking for both a region and a time, into the following.

The present invention comprises the method of finding the fraction of a BME's messages, or of a set of BMEs' messages, received when the user was in some chosen geographic region, and, optionally, when the messages were received in some chosen time interval.

Suppose that the sender information can be considered to be valid in most cases, in a given set of messages. Currently, for email, that is typically not the case. But in other ECMs, like cellphones and SMS, the sender phone number is generally considered reliable.

The present invention comprises the method of finding the fraction of a BME's messages, or of a set of BMEs' messages, received when the sender was in some chosen geographic region, and, optionally, when the messages were received in some chosen time interval.

Combining the previous two methods gives us this dependent method.

The present invention comprises the method of finding the fraction of a BME's messages, or of a set of BMEs' messages, received when the sender was in some chosen geographic region and the user is in some chosen geographic region, and, optionally, when the messages were received in some chosen time interval.

3.5 Social and Scale Free Networks

- - -

Suppose from a set of BMEs, we remove most of the spam, perhaps by using styles that suggest a BME is spam, like having more than one subject or more than one sender. Then we are left with mostly individual, nonspam messages and newsletters. In either case, we can expect that the senders are now canonical, i.e. not forged. Given this, we can make social networks, using the To, CC and From lines in the case of email. (In other ECMs, we would use the analogs of these, if they exist.) The social networks have useful commercial applications. Being able to identify networks would have merit, for example, in allowing advertisers to offer targeted marketing.

Define users or domains A and B as “linked”, as derived from a set of BMEs, if at least of the following is true:
1. A BME has a message with A in its To line, and another message with B in its To line.
2. A BME mentions A and B in one of its messages' To line.
3. A BME mentions A and B in one of its messages' CC line.
4. A BME mentions A in one of its messages' To line and B in the CC line, or vice versa.
5. A BME has a message from A to B in its To line, or vice versa.
6. A BME has a message from A to B in its CC line, or vice versa.
7. A BME has a message with A, which here is a domain, in its body, and B in its To line, or vice versa.
8. A BME has a message with A, which here is a domain, in its body, and B in its CC line, or vice versa.

Notice that apart from the first item, all the other items mean that there was a message, as opposed to a BME, that associated A and B directly. The last two items also let us handle the case when a sender might be forged in some messages.

Define users or domains A and B as “indirectly linked” by a set of BMEs if they satisfy both conditions:
1. They are not linked.
2. A is linked to some other user or domain, which in turn in linked to another user or domain, et cetera, until a user or domain is linked to B.

The present invention comprises the method of finding the subset of a BME's messages, or of a set of BMEs' messages,with recipients or senders associated with a given set of users or domains (“Rho”), by one or more of the following steps, where a recipient could be a user or a domain, and likewise for a sender:
1. A recipient or sender is in Rho.
2. A recipient or sender is linked to a user or domain in Rho.
3. A recipient or sender is indirectly linked to a user or domain in Rho.

Notice that if we are a message provider, the above definitions and methods are not restricted to our local users. Here, a user or domain could be external, and sending or receiving messages to or from our users.

The present invention comprises the method of building clusters of items from a set of BMEs by using the definitions of linked and, optionally, indirectly linked.

The difference between this method and that of building clusters of domains in ['1745] is that in the latter, we were not using items 2-6 in the above definition of linked. The method below is a simple extension of our finding of nexii from clusters built using ['1745], where a nexus is defined as splitting a cluster into two or more disjoint sets.

The present invention comprises the method of finding nexii from clusters of items, built from a set of BMEs by using the definitions of linked and indirectly linked.

Look at the above definition of two items, A and B, being linked. The last 4 criteria differ from the previous ones, in that they let us draw a directed arc from A to B if there exists a message from A to B.

Define a user or domain A, as “upstream” from a user or domain B, as given by a set of BMEs, if A is linked to B and one or more of these conditions is true:
1. There is a message from A to B, or it has A in its body and B in its To or CC lines.
2. There is a path of nodes that are linked to each other, with one end at A and the other at B, and A is connected to its neighbor in the manner of the previous item, et cetera, all the way to B: A→ . . . →B.

If A is upstream from B, we define B as being “downstream” from A.

Notice that if A is upstream from B by the second condition, that it does not necessarily mean that there was a sequence of messages, one after the after, that led to the building of the path A→ . . . →B. But sometimes it may be useful to actually want find such a causal sequence.

Define a user or domain A as “strictly upstream” from a user or domain B, as given by a set of BMEs, if one of these conditions is true:
1. There is a message from A to B, or it has A in its body and B in its To or CC lines.
2. There is a message from A to another user or domain Al, and after this has been received by Al, there is a messsage from Al to another user or domain . . . etc to B.

Notice that here we deliberately leave unspecified whether the times in the previous item are measured upon transmission or receipt of a message. This can be a policy choice, to use one or both.

Define an item A as “strictly downstream” from an item B, as given by a set of BMEs, if B is strictly upstream from A.

Obviously, A is strictly upstream from B=>A is upstream from B.

The present invention comprises the method of starting from a set, A, of BMEs, and a set, B, of items, like users or domains, and finding the items in A which are downstream or strictly downstream or upstream or strictly upstream from those in B.

Consider now the case when a user or domain is upstream, and is sending messages to another set of users or domains. If the sender is also a nexus, then it increases the chances that it is a bulk sender. Because it is sending to at least two disjoint groups. While we have methods to detect bulk message senders, it is useful to have another method. But in general, a bulk sender might receive occasional messages from its recipients, like asking to unsubscribe. Accordingly, we define the “flow ratio” for a user or domain to be the number of messages sent by it, or which have it in their bodies, if it is a domain, divided by the number of messages sent to it, if the latter is not zero. Otherwise, we define the flow ratio as infinite.

Therefore, below, we have two ways to detect bulk senders, where the second is the stronger.

The present invention comprises a method of finding possible bulk senders by starting with a set of BMEs, and finding the items, like users or domains, which are (upstream of other items, and are not downstream from any item) or which have flow ratios greater than some chosen value.

The present invention comprises a method of finding possible bulk senders by starting with a set of BMEs, and finding the items, like users or domains, which satisfy these conditions:
1. They are (upstream of other items, and are not downstream from any item) or which have flow ratios greater than some chosen value.
2. Are nexii.
3. [Optional] We take the disjoint sets of items defined by a nexus and find an interest classification of these sets, by whatever external means, and we find that the sets have little or no overlap in interests.

There is also an interesting application that can be useful to a message provider. Sometimes, a spammer might open an account at a provider, simply to receive test spam messages sent by the spammer from outside the provider. By experimenting with the composition of a message, she can adjust it until it gets past the provider's antispam filters. Thence, she can send bulk copies of the message to addresses at the provider. The spammer's account is a probe account, but different from those than might be used by the provider itself. In general, it is hard to detect a spammer probe account, because she will not use it to emit spam, and it receives new, leading edge spam in small numbers.

The present invention comprises a method to detect a possible spammer probe account by the following steps:
1. The account (user) is downstream from other accounts, or it has a flow ratio less than some chosen value. (That is, the account is used mostly to receive messages.)
2. Of the messages sent to the account, a fraction, larger than some chosen value, is indicated as possible spam by the provider's antispam methods. These messages might be rejected by the provider or sent to the account and indicated in some fashion as possible spam.
3. Of the messages received by the account, a fraction, greater than some chosen value, is later included in BMEs of bulk messages received by the provider.

The second item above includes the case where the provider might be using our method of applying an RBL against domains found in the body of a message. In this case, a spammer needs to send a test message with the actual domains used by her, in order to test if the provider has those domains in its RBL.

The third item lets the provider detect leading edge spam, albeit after the fact, when bulk copies of it have been received. Notice that this can be done even if the spammer deletes a successfully received message immediately upon receipt, so long as the provider applies our steps in ['0046] to all incoming messages.

Suppose that the provider has found a suspected probe account, after the fact. The provider can see if this happens again with another message and bulk copies of it, to increase confidence in the diagnosis. So suppose the provider is willing to consider an account as a spammer probe account.

The present invention comprises a method of a provider using the knowledge that an account is a spammer probe account in any one or more of the following ways:
1. Add any domains in its received messages to an RBL, where the domains are found from the bodies of the messages using ['0046]. This nullifies the value of bulk copies, if the provider can then block them by finding domains in their bodies.
2. Verify if the sender field is accurate. The spammer might not bother to forge this. If so, this might give some indication to later investigation as to the spammer's whereabouts.
3. Obtain the network addresses of where the spammer is, when she connects to the provider. (For the same reason as the previous item.)
4. Manually study the messages received that have passed the provider's filters, for clues to improve the filters.
5. Suspend one or more of the steps in the filters, for incoming messages to the account. To some extent, this is mutually exclusive from the previous item. The idea here is to stop the spammer from probing the limits of the filters.
6. Close the spammer's account.

Now consider the degree of separation of two items, from each other. The concept of degree of separation was first used by Milgram. (“The Small World Problem”, Psychology Today, vol 1, 1967.) This can be applied to the case of BMEs as follows.

The present invention comprises a method of starting with a set of BMEs, A, and an item, like a user or domain, B, and finding the degree of separation of an item in A from B. This is defined as infinite for an item in A for which there is no connection, direct or indirect, to B. For an item in A, for which there are connections to B, the degree of separation is the minimum number of items linking it to B, where we start the count at 1. That is, the degree of separation is the length of the shortest path.

While degrees of separation have been measured in the prior art for various data types, the above method is specific to the context of BMEs.

The present invention comprises for a set of BMEs, the measurement of P(k) and the use of it to characterize the set, where P(k) is the probability that a node is connected to k other nodes, where the nodes can be in any of the spaces (destination, hash . . . ) recorded in a BME.

Given that from a set of BMEs, we can extract several networks, then we can compare the P(k) found from the different spaces, to see if there is any useful correlation.

For scale free networks, it has been found (“Emergence of Scaling in Random Networks” by Barabasi and Albert, Science, vol 286, p. 509, 15 Oct. 1999) that P(k)˜k**(−gamma), where gamma characterizes the network.

The present invention comprises for a set of BMEs, the measurement and use of gamma, as defined above, to characterize the set.

Of course, if the network is not scale free, then gamma is not be a useful quantity. But to the extent that a set of BMEs has a scale free network, then gamma is useful.

Define, for an arbitrary network, the clustering coefficient of node j, with k_j links, as
C(j)=2* n_{—}j/k_{—}j*(k_{—}j−1)

where n_j is the number of links between the k_j neighbors of j. For k_j links, the maximum possible number of links between these nodes is k_j*(k_j−1)/2, so C(j) is between 0 and 1. (“Hierarchical Organization in Complex Networks” by Ravasz and Barabasi, Phys Rev E 67 (2003).)

The present invention comprises for a set of BMEs, the measurement of the average clustering coefficient, as a function of the number of links, and the use of it to characterize the set, where these are found for any of the spaces recorded in a BME.

One use of this is to see if C˜1/k, where k is the number of links. If so, then this indicates a hierarchy of clusters. So any classification or grouping of the nodes might be applied to this hierarchy.

Now consider a cluster, of any type, as found by ['1745] or the methods here as applied to a set of BMEs. With each point in a cluster, we compute a degree of separation of that point from the rest of the cluster, by averaging the degrees of separation of that point from the other points in the cluster. The present invention comprises this style. It is a useful measure of how connected a point is.

The present invention comprises, given the previous method, a method of finding the item/s with the lowest degree of separation, and associating these with the cluster.

The present invention comprises a method of averaging the degree of separation of a node in a cluster, over all the nodes, and defining this as the “diameter” of the cluster and using it to characterize the cluster.

The present invention comprises, given a cluster of any type, as found by ['1745] or the methods here as applied to a set of BMEs, a method of finding the largest degree of separation and using it to characterize the cluster.

From the above, we see that the lowest, average and largest degrees of separation may be used to jointly characterize the connectivity of a cluster. Specifically, the item/s with the lowest degree may be considered as the center/s of the cluster, being highly connected.

The present invention comprises that given a cluster, of any type, as found by ['1745] or the methods here as applied to a set of BMEs, if we choose two disjoint subsets of the cluster, we can find the average degree of separation of the subsets from each other.

When we make a cluster, consider two items in it, A and B, that are connected. In terms of the degrees of separation, we say that A and B are separated by 1 degree. The fact that they are connected means that there is at least one BME that links them. But, thus far, we have no measure that takes into account the number of BMEs that might link them, or the number of messages within a BME that links them. It might be useful to do this, in part because, say, if A and B exchange a lot of messages, we might consider them closer than if just one message went between them. Likewise, if A and B are linked by messages, some from A to B, and some from B to A, then we might choose to regard them as closer than if all the messages were in one direction.

The present invention comprises a method of finding the modified degree of separation between two items in a cluster, as found by ['1745] or the methods here as applied to a set of BMEs, where the items are directly connected, and the modification uses, in some way, the number of BMEs or the number of messages in BMEs, linking the items, or the directionality of the links or the timing in the BMEs' messages.

Clearly, there are an infinite number of ways to do the above. But there is one way so easy to compute that we have the explicit method below.

The present invention comprises a method of finding the modified degree of separation between two items in a cluster, as found by ['1745] or the methods here as applied to a set of BMEs, where the items are directly connected, and the modified degree of separation is given by the reciprocal of the number of BMEs linking the items, or by the reciprocal of the total number of messages summed across the BMEs linking the items.

The present invention comprises a method of finding a modified degree of separation between any two items in a cluster derived from a set of BMEs, by using the modified degree of separation between adjacent items, as given in the previous two methods.

The present invention comprises a method of starting with a set of BMEs, A, and an item, B, from a space covered by the BMEs, and finding the modified degree of separation of items in A from B.

Now consider a cluster, of any type, as found by ['1745] or the methods here as applied to a set of BMEs. With each point in a cluster, we compute a modified degree of separation of that point from the rest of the cluster. The present invention comprises this style. It is a useful measure of how connected a point is.

The present invention comprises, given the previous method, a method of finding the item/s with the lowest modified degree of separation, and associating these with the cluster.

The present invention comprises, given a cluster of any type, as found by ['1745] or the methods here applied to a set of BMEs, a method of finding the largest modified degree of separation and using this as a measure of the cluster's connectivity.

The present invention comprises that given a cluster, of any type, as found by ['1745] or the methods here applied to a set of BMEs, if we choose two disjoint subsets of the cluster, a method of finding the modified degree of separation of the subsets from each other.

In the study of networks, an often useful measure is the propagation time of a message through a network. For our clusters, and for social networks in general, this is different from the average time that a message might take to go from one node to another, in an underlying network. What is of interest here is some way to measure how a message, containing some idea, is replied to or re-sent by nodes (e.g. users). The utility might be to see how an advertising message, say, filters through a network, and the amount of time it takes to do so.

The present invention comprises that given a cluster, of any type, as found by ['1745] or the methods here applied to a set of BMEs, a method of finding that a node (e.g. user) has retransmitted a received message, or part thereof, and using the difference between the received and transmitted times as a measure of the propagation time of that node; doing this for any several such messages to find an average propagation time for the node; doing this across all nodes to find an average propagation time for the nodes in the cluster.

Note that in the latter case, it is an average time per node, and not an average time for a message to percolate through the cluster. For this, we might choose, perhaps, to multiply the average time per node by the average (optionally, modified) degree of separation of the cluster. The present invention comprises this.

3.6 Higher Order Styles

- - -

The present invention comprises the use of any combination of the Message Styles and the styles defined hitherto in this section 3, in evaluating a set of BMEs, or users or domains or relay domains or hashes, where these latter 4 are assumed to have associated BMEs.

The evaluations may be for various purposes, including, but not limited to,
1. designating a BME as possible spam.
2. designating a BME as a newsletter.
3. designating a domain or a relay as a possible spammer domain.
4. designating a cluster of domains as a possible spammer cluster.
5. designating a user as a possible spammer, where the user could be a sender or a recipient of messages.
6. designating a BME as a possible Phishing scam.

For example, consider what we might do to detect Phishing. In the Message Styles, we discussed how to find Phishing when we are dealing strictly at the message level. But if we have BMEs, more powerful techniques become possible.

The present invention comprises this method to detect if a given BME is Phishing:
1. The BME has HTML.
2. Optionally, there is a <form> tag. So that the reader can fill out the form and then submit it.
3. There are at least two different domains found from the body.
4. One domain is in a list of companies that may be possible victims.
5. The domain in the From line matches the previous domain.
6. If there is a form tag, the domain in the submit button of the form is not in this list of companies.
7. [Optional] Too many relays in the BME. (Phisher is trying to hide her location.)
8. [Optional] The BME has only one From line. (Well-behaved, here.)
9. [Optional] The BME has only one Subject line. (Ditto.)
10. [Optional] Is the country corresponding to the domain in the submit button different from the country that we are in?
11. [Optional] Is the submit button of a form tag using a secure protocol, like https?
12. [Optional] Does the link in the submit button contain the domain in the From line as part of the first 50 characters, say. Suppose the phisher is pretending to be goodco.com. The From line might say something like report@goodco.com. The link might say “https://www.goodco.com.398d.atestcgi-bin.sadf . . . ”. Notice what the phisher is trying to do here. If the user moves her mouse over the button, this link contents will be shown at the bottom of the browser. So it appears to a quick glance that indeed, the link is going to goodco.com. In fact, the actual domain is further to the right.

4. Using Styles

- - -

Here we describe several possible ways that styles can be used, different from those already described. First we define some notation.

Let S(Q)=styles of a set Q of items, where the items are anything that we can find styles of. An item might be a message, for example. An item can also be a cluster, as we have defined in ['1745]. Let C_d be a cluster of domains, C_h be a cluster of hashes, C_u be a cluster of users, and C_r be a cluster of relays. Let {C_d} be a set of clusters of domains, and likewise define {C_h}, {C_u} and {C_r}.

The present invention comprises the finding S({C_d}) to characterize each cluster in a set of domain clusters by its average style. So S(C_d) can be used as a signature of a particular cluster. This can be of use in some circumstances.

For example, suppose a particular cluster, call it Alpha, has 90% of its members, domains in this case, with the style of invisible text. And for all the other clusters, none has more than 15% of its members with invisible text. Then suppose we are presented with data for another domain, that is different from any of our existing domains. But 80% of the messages pointing (linking) to this domain have invisible text. Then we could classify it, probabilistically, as being affiliated with Alpha. Now, if by other means, we have determined that Alpha is a spam cluster, we now could say that the new domain is likely to be a spam cluster. In this example, we have kept it deliberately simple. In practice, we might choose more involved criteria. Or we might use the above reasoning as a starting point, and then look more carefully at other properties of the new domain, so find more evidence that it might be a spam domain.

The present invention comprises the finding S({C_h}) to characterize each cluster in a set of hash clusters by its average style. So S(C_h) can be used as a signature of a particular cluster. See the earlier example for a possible use.

The present invention comprises the finding S({C_u}) to characterize each cluster in a set of user clusters by its average style. So S(C_h) can be used as a signature of a particular cluster. See the earlier example for a possible use.

The present invention comprises of the finding S({C_r}) to characterize each cluster in a set of relay clusters by its average style. So S(C_h) can be used as a signature of a particular cluster. See the earlier example for a possible use.

The present invention comprises of the finding of the average style of each cluster in a set of clusters, as a characteristic of the cluster. Here, a cluster is any such cluster than can be found by the method of ['1745], and that is not already specifically mentioned above.

Instead of dealing with clusters, we can also discuss more general groupings. Suppose we have a set of messages M={M_i|i=1, . . . ,n}. Let us split M into two subsets, M=N+P, where this can be done by any means, programmatic or manual or a combination of both. Then we find S(N) and S(P). Suppose there is a subset of styles such that the values of these in S(N) are quite different from their counterparts in S(P). Then this subset and the corresponding values might be used as a characteristic of S(N), and the subset and the other values as a characteristic of S(P). We can then use these as predictors. So given a new message, we find its style, and thence use the predictors to suggest whether the message might be related to N or to P.
1. The present invention comprises of the case where M is split into N and P by manually or programmatically determining that N is bulk messages and P is not bulk messages.
2. The present invention comprises of the case where M is split into N and P by manually or programmatically determining that N is spam and P is not spam.

Now consider again M={M_i|i=1, . . . ,n}. We find {S(M_i)} for all i=1, . . . ,n. We can use these values to find subsets of M, based on an arbitrary combination of styles, and a choice of possible range of values of each style.
1. The present invention comprises, from a given subset of M found via styles, the making of domain clusters, using the method of ['1745] applied to this subset.
2. The present invention comprises, from a given subset of M found via styles, the making of hash clusters, using the method of ['1745] applied to this subset.
3. The present invention comprises, from a given subset of M found via styles, the making of user clusters, using the method of ['1745] applied to this subset.
4. The present invention comprises, from a given subset of M found via styles, the making of relay clusters, using the method of ['1745] applied to this subset.
5. The present invention comprises, from a given subset of M found via styles, the making of any type of clusters, that can be found using the method of ['1745] applied to this subset.

Consider a similarity tree, as made by the methods of ['1745, '1789, '1899, '1014]. We are in some space, (e.g. domain, hash, user, relay, message), and we have an element in that space, call it Gamma, and we want to see others closest to it, according to some metric. (An instance of a metric can be that given in ['1745], where the user can choose the ordering of spaces.) We make a tree, with its root being Gamma. The rest of the tree is given by applying the metric. We can then apply styles in the following ways.

1. The present invention comprises the finding of styles of the root; collectively of its children, which are the nearest neighbors of the root; collectively of its children's children, which are the second nearest neighbors of the root; etc, and their usage in characterizing the root, nearest neighbors, second nearest neighbors etc. So that, as we move further away from the root, in the sense of this tree, are there useful changes in the styles that let us characterize each “ring”? (Of course, there might not be in any specific case.)

2. The present invention comprises the finding of styles of the root, and collectively for each subtree whose root is a child of the original root, and their usage in characterizing the subtrees and the root.

In ['1745], we showed how having multiple hashes per message let us define similarities between messages, based on how many hashes they have in common. More generally, we were able to build a similarity tree, across the various spaces.

The present invention comprises the use of styles in applying new ways to measure distances between messages. This is generally useful, for it lets us investigate possible connections between messages, and hence of possible connections between their domains and their authors.

In general, there are an infinite number of ways to define a metric. (“Elementary Classical Analysis” by J Marsden, Pan Macmillan 2002.) We give an example of how styles could be used in this fashion. Let us define the modified Euclidean distance between two messages, V and W as
d(V,W)=sum from i=1 to m of (f_{—}i*[S_{—}i(V)−S_{—}i(W)]\hat{ }2)
where m=number of styles
f_i>=0 for i=1, . . . ,m. These are the weights.
S_i(x)=style i of message x, in the range [0,1].

By choosing various specific values of {f_i}, we can emphasize or deemphasize particular styles. In particular, if we set a given f_i=0, we are ignoring style i.

The present invention comprises the use of styles in applying new ways to measure distances between clusters, where these are any type of clusters that can be extracted from a set of messages using ['1745]. The utility of this is the same as that for the previous method.

If you look at the example of the modified Euclidean distance between two messages, and now interpret V and W as representing clusters, then clearly, the example can also be applied to clusters.

5. Other Electronic Communications Modalities

- - -

Most of our discussion has been about the important case of spam in email, and especially about HTML email. But many of the methods can also be applied in other ECM spaces, like Instant Messaging or SMS. Some IM implementations can display HTML.

In general, whenever an ECM space lets messages have HTML, then many of the methods mentioned above can be used. Or, if the space lets messages have some type of markup language where there can be links in the messages to other locations on a network, then many of the methods can be applied.

For example, in the Message Styles, we mentioned that an HTML message can have random comments. This can also arise in any other markup language that allows comments to be written, and where the viewing instrument (the equivalent of a browser) does not usually show these comments, then a spammer can write random comments, to make unique versions of a message. Likewise, our canonical steps can be applied to these copies, to remove comments.

Thus, we can make BMEs, and many of the methods in section 3 can also be applied here.

6. Correlation of Electronic Communications

- - -

We take the analysis of the previous section further, by finding styles that relate to the correlation of electronic communications across different ECM spaces, rather than just confined to one such space.

6.1. Exchanging Flat Lists (Between Email and Search Spaces)

- - -

Suppose we are an email provider and we want to block incoming messages that are bulk and unsolicited (spam). Suppose we have found an RBL, derived from any combination of analysis of our email, RBLs from other email providers, or RBLs from central RBL sites, like Spamhaus.

Our RBL can be enhanced by a further step. Suppose a search engine has found a set of domains that it is highly certain are link farms. It could have found these using our methods described above in this application, or by other means, or by using our methods in combination with other means. This list of link farm domains has value to us, because it may be strongly suggestive of spammer domains. We may then choose to reject or label as “bulk” any email that links to these domains. This is equivalent to creating a Boolean style associated with an email, that is set true when the email links to any of those link farm domains; and then rejecting any email with this style set true.

Furthermore, we can then use this link farm domain set as a nucleation set and build a domain cluster around it. And then thus reject or label as “bulk” any email links to this cluster. There is a Boolean style that can be defined here, which is closely related to that of the previous paragraph. Or we can use these link farm domains to supplement any list of spammer domains that we have already found. In other words, find the domains in the link farm domains that are not already in our list of spammer domains. Add these to our list of spammer domains, and thus, hopefully, reject or label as “bulk” some more email.

But why might we regard a link farm domain as a spammer? The reason has to do with the overlapping business models of spamming and link farms. Spammers usually have to buy and maintain domains. It is these domains which are pointed to by email they send. This assumes that they send email with selectable links, which is most spam. Because of the low clickthrough rates of spam, and the often limited lifetime of their domains (because of various antispam measures), spammers face continual economic pressure. What some spammers do to generate more revenue is to offer their services as link farms, since a spammer may have several domains operating concurrently anyway. Alternatively, a link farmer searching for an extra revenue stream might be well positioned to issue spam.

Thus we claim that it may be advantageous to consider a list of link farms as spammer domains. How can this fail? If the link farm is indeed sending spam, then we are correct in considering it as a spammer. But if the link farm is not sending spam, we are highly unlikely to see its domains in our analysis of our email. It might be objected that in this case, we are unnecessarily blocking these particular non-spamming link farms, and that hence we are wasting disk, memory and computational time. It turns out that this is negligible. Disks are now typically many gigabytes in size, and soon, if not already, will be over 100 Gb. Using the standard file storage format of a text file, we have found that an RBL domain takes up typically less than 25 bytes. So even adding a thousand non-spamming link farms to an RBL, say, only adds around 25 kb. Negligible. Likewise, most memory, especially on a server computer that receives email, is nowadays often several hundred megabytes. So the extra domains add negligibly to memory usage. Lastly, most methods of searching an RBL represent that RBL as a hashtable. This means that the time to find an entry, or to find if an item is not in the table, scales as log(n), where n is the number of entries in the table. Hence there is negligible effect on the search time.

The only case remaining is if the link farm is sending low frequency mail. If we choose a policy of admitting email that canonically is low frequency (most often canonically unique), then we can pass these through to our users, and still guard against higher frequency email from link farms.

At a strategic level, it benefits us to block link farm domains, when fighting spam. Because we reduce the incentive for spammers to have an extra revenue stream by being a link farm. Thus, if we, and enough other email providers do this, it adds to the economic pressure on spammers.

Now, instead of imagining that we are an email provider, assume that we are a search engine. Why would we supply a list of link farms to email providers? We might be able to sell it to them on a regular basis, because this has some economic value to them. But it also has extra value to us to do so. From the above discussion, we want to stop link farms. By supplying this list to email providers, we reduce the attractiveness of spam as another revenue model for link farms. Anything which restricts the economic appeal of link farms is good for us.

Now imagine that we are no longer a search engine. Earlier we discussed several ways that a search engine might identify link farms. Given overlap between some spammers and link farms, it follows that an RBL from an email provider may well have utility to a search engine. It can use this RBL by taking each entry and applying the methods mentioned earlier to look for indications of link farms.

Gathering these ideas together, we can see that there is merit in a search engine and an email provider regularly swapping information. The search engine offers its list of link farms, and the ISP or company offers its RBL. (The two parties may negotiate as to whether there is need for extra payment, and by whom.)

If the email provider gets link farms from a search engine and adds them to its RBL, the link farms have potentially greater efficacy if the RBL is applied to email using our methods in ['0046, '1745, '1789]. Specifically, instead of simply applying the link farms against the domains in email headers, the email provider also does so against domains in links in the bodies of the email.

Of course, it is possible for a search engine to use spam domains found directly from an RBL website. This can be in place of, or in addition to, getting RBLs from one or more email providers. But there are advantages to the search engine in getting an RBL from an email provider, as opposed to exclusively doing so from an RBL website. These include, but are not limited to:
1. The RBL website can be a single point of failure. Because its main purpose may be the aggregation and dissemination of an RBL, it might be widely known for this. Hence, spammers have an incentive to attack it by various means. These include, but are not limited to, Distributed Denial of Service (DDoS) and the submission of false data (e.g. domains that are not spammers) to discredit the RBL.
2. If the website is mirrored, possibly in part to defend against such attacks, there might not be that many mirrors. And these mirrors are usually publicly known. So spammers can attack those as well.
3. An email provider that offers its RBL to a search engine, and the search engine itself, do not need to publicize this arrangement.
4. Even if the arrangement is publicly known, remember that an email provider's main purpose is to provide email. So even if a spammer could successful implement a DDOS against it, this would shut down users' access to their email. So they cannot get the spammer's mail. Useless “win” to the spammer.
5. Suppose it is publicly known that one email provider and a search engine have this arrangement. If a spammer could shut down the email provider, it might choose to do so, notwithstanding the previous reason. Because the spammer might then consider that she can still send mail to other email providers, and, presumably, run a link farm. To counteract this, the search engine might have data sharing arrangements with several email providers, so that a single email provider is not a single point of failure, to the search engine. This also protects each email provider, because a spammer would have to knock out all the email providers involved. Which is harder, and even if successful, would have a higher cost to the spammer in terms of lost readership.

We have left unspecified how the email provider finds its RBL, that it then can send to a search engine. This is not dependent on our methods of ['0046, '1745, '1789, '1899]. But if those methods are used to find an RBL, then for the purposes of sending to a search engine, we claim several advantages, including but not limited to the following:
1. From its email, the email provider can generate an RBL frequently, say daily or even at shorter intervals. This compares favorably with the search engine obtaining an RBL from a central site, like Spamhaus. Such sites can update their RBLs hourly, say, but that is not the throughput. That is, the time between when a possible spam domain is submitted to the site and when the site adds that domain to its publicly available RBL can be much longer; days or even weeks. There are several reasons. Such central sites must guard against false information being fed to them, to discredit their lists. So they often perform manual checking on submissions. Which takes time. Or they might also require that several or more parties send them the same domain, as extra confirmation that the domain is a spammer. This also takes time. Plus, there is also the earlier length of time that it takes an email provider to come to a conclusion that a domain is a spammer. This length of time needs to be added to the time that a central RBL site will take to process that submission and presumably approve it and publish it. Whereas if an email provider uses our methods, in an automatic mode, it should be able to offer a list of bulk domains far faster.
2. The bulk domains are the ones pertinent to the email provider's situation. These are the domains sending it the most bulk mail. An RBL from a central site may have domains that are simply not seen by the provider. If the RBL website has global scope, like Spamhaus, then it may list domains that send spam mostly to other parts of the world. This assumes that the email provider has a limited geographic scope.
3. But suppose the email provider has global scope. It is still possible that the bulk domains seen by it are not necessarily those seen by others.
4. The number of bulk domains generated may easily be greater than those offered by a central RBL website that just does primarily manual assessment of domains.
5. The bulk domains generated are fresh. That is, they can be derived from very recent email, possibly within the last 24 hours or less. Presumably, these domains are currently active. So the search engine has the option of deleting from its lists, domains which have not been appearing, in RBLs sent from email providers using our methods, for some specified time that the search engine gets to set. This might reduce the computational requirements of searching for link farms.
6. We recommend that the order of entries in the RBL be in terms of decreasing frequency of messages corresponding to an entry. That is, the first entry is the domain that most messages point to, the second entry is the second most frequent bulk domain, etc. If the RBL is presented in such a way to the search engine (as opposed to, e.g. alphabetical order), then this has utility to the search engine. It tells which are the most frequent issuers of bulk mail. The search engine might use this for a more efficient hunt for link farms. Under a possible assumption that the largest spammers might also be more likely to have link farms. Of course, there is no intrinsic difference between this ordering and an ordering based on increasing frequency of messages. The search engine just needs to know that the list is ordered, and in ascending or descending frequency.
7. The methods are objective, assuming that the email provider does not add entries to its list based on a manual assessment of those entries. What this means is that the search engine can regard the list as unaffected by any possible subjective assessment by personnel at the email provider.
8. A variation on the previous point is for the email provider to offer two lists. The first is found by our methods. The second consists of extra domains that have been manually assessed as definitely spammers, according to some criteria set by the email provider. If the search engine regards the email provider as reliable in its subjective assessments, then it could use both lists.

There is an analogy here to what we described in ['1745]. There, in finding and displaying clusters of spammer domains, it can be seen that this is a higher level structured view of the spam problem. The recipient of a single spam message, or even many, typically never sees these correlations. In large part, it requires our canonical hashing methods of ['0046] and ['1745] to make these correlations. We suggested in ['1745] that it acts as a “force multiplier” to block against an entire cluster, rather than just subsets of that cluster.

Likewise, when we used our methods in ['0046, '1745, '1789, '1899] to attack spam, this was in a domain space found from emails. Imagine this domain space as one conceptual dimension. Now imagine another domain space as a second conceptual dimension. This space is found from websites linking to each other. In this dimension, search engines have been tackling the problem of link farms.

Hitherto, neither the antispammers or the search engines have made the tie-in between the two problems. Though some search engines have labeled link farms as “search spammers”, as mentioned earlier. This label appears to have been used primarily out of analogy with email spammers. We have found no evidence from publicly available information that the search engines have made the deeper connection offered here. The coordinated attack we suggest has the promise of acting as an extra force multiplier, over and above those in ['0046, '1745, '1789, '1899].

We posit that the exchange of data between search engines and email providers has utility.

Also, it shows a business model wherein a search engine might want to offer an email service. Such a service might be free or partially free. By aside from any direct revenue stream, the search engine could analyze the incoming email for an RBL and thence as a seed to finding link farms.

If the email provider and the search engine are different organizations, it is also possible that instead of a data exchange, we have a one way flow of data. The recipient might offer other compensation in lieu of its spam domains or link farm domains. Or, the provider might even offer its data for free. Maybe just to have its opponent attacked in a different ECM.

Above, we have discussed the case for one email provider. There is an important other case. There could be a group of email users, whose email is obtained via several email providers, connected in a peer-to-peer (P2P) network. This group could arise because of a commonality of shared interests, professional or recreational. Or, it could be chosen by some means outside this discussion. The group might exist indefinitely, or for some temporary time interval. Members of the group may apply our methods of ['0046, '1745, '1789, '1899] to aggregate hashes of their messages and thence find clusters of these and spam domains and make an RBL. The group, or members of the group, could then exchange this with a search engine. (Or perhaps the data transfer could be one way.) If so, our statements above apply to this situation.

Currently, a group of users who span several email providers cannot do this. But there is no fundamental technical reason why this cannot be possible in future.

Our methods are also applicable for email-like services. These include newsgroups, blogs, bulletin boards and RSS news feeds. These may be moderated or unmoderated, where we consider unmoderated as meaning that a user or program can submit a message to the service, which then automatically makes it viewable, without manual scrutiny. The service may have some automated program checking the message according to some criteria (e.g. no obscene words). The unmoderated (in our sense) service may actually have a human moderator. But she might act only after the fact; for example, by deleting already posted messages that users subsequently object to.

In general, the services may have problems with spam. The services can also benefit by filtering messages against an RBL, where the RBL is applied to the body of the messages in a similar way to ['1899]. This RBL, or additions to it, can be obtained from a search engine.

Even in the case of the service having a human check each incoming message, the use of an RBL would still have merit. It is possible for a spammer to write a message where the topics in the text bear no correlation to those in a location on a network that is pointed to by the message. (This is similar to email spam where the Subject line is misleading, as compared to the body of the message.) Notice that the information about the location, in the message, need not necessarily be selectable by the software most commonly used to view the messages. So that, for example, someone wanting to go to that location might need to type it manually or copy and paste it from the message. In any event, the misleading text in the message might be, in part, to fool a moderator into permitting the message to be approved, if the moderator does not go to the locations indicated in the message body.

6.2. Exchanging More Structured Information (Between Email and Search Spaces)

- - -

In the previous example, we suggested that an email provider offer its RBL to a search engine, and the search engine offer its list of link farms. Those lists were flat in the following sense. Suppose the RBL is mostly derived using our methods in ['0046, '1745, '1789, '1899]. It comes from a set of clusters that have been considered to be sending spam. The domains in each cluster are then put into a total RBL. The RBL does not record which cluster a domain came from. The cluster information is discarded. Though perhaps the domains in the RBL might be ranked in decreasing order of frequency of messages which point to them, say. Even so, there is no cluster information retained. Likewise, when a search engine offers its list of link farms, it might or might not have information in the list indicating which domains are in a given link farm. But in either case, if the list gets incorporated into an RBL, any such information is discarded, because the RBL is flat.

There are alternatives. Suppose the link farm information lists a set of link farms, and under each link farm, the domains belonging to it. The email provider can take this and use it upstream, before the RBL is made. Each set of link farm domains can be considered as a cluster and used as nucleation points in ['1745], without any email being used to derive this information. This is an extension of the methods in ['1745]. Then, after ['1745] is applied to the email, the original link farm sets may end up as subclusters of larger clusters. This is useful, because it lets us use data that is in a different ECM space to improve the efficacy of our clustering in email space. The larger the clusters we can build, the more powerful the methods of ['1745].

How is this different from the previous example of just adding the link farms to the RBL? Consider this simple example. Suppose the search engine just has one link farm, with domains A and B. On its own, the email provider has found two clusters, alpha and beta. Alpha has three domains, {A, G, H}, and only a few emails that point to these. So the email provider decides not to consider alpha as a spam cluster. But it considers beta to be a spam cluster. And suppose beta is {B, C, D}. So its RBL consists of {B, C, D}. If we use the method of the previous example, then the email provider will add A and B to its RBL, which now is {A, B, C, D}. Now suppose that the email provider uses A and B as a starting cluster, before it finds clusters from its email. It will end up with the spam cluster {A, B, C, D, G, H}, because the A-B connection obtained from the search engine lets it also include G and H from the original alpha cluster. Hence it can apply these to its email and block more of them as spam, and also more, presumably, of future email. The efficacy of the antispam methods is increased.

Consider now from the vantage point of the search engine. Suppose it gets from an email provider not a flat RBL, but a list of spam clusters, and for each cluster, the domains within it. We said earlier that the search engine could use an RBL as a starting point to looking for link farms. But having cluster information might lead to more optimized searching. This is especially useful if the search engine does not maintain a global table of hashes of the web pages that it has surveyed.

It can start with a domain in a given cluster, and then make N-spheres as before, and do likewise with the other domains in the cluster. It is possible that if the domains are in a link farm with highly similar pages, that this may be quickly found, without the need for doing all the steps in making the N-sphere. If there are now partial overlaps between these spheres, it has to decide if this is indicative of a link farm. There are many ways it might decide on this. There may be gray areas where it is unclear whether two (or more) domains are in a link farm. In this case, if the domains came from a cluster supplied by an email provider, then the search engine might use this as a deciding factor, and thence consider the domains as part of a link farm. Or, a Bayesian or fuzzy set or other statistical method might be used.

This method of starting from a cluster can be effective against a link farmer who has split her farm into several farms that are disjoint. That is, no page in a farm points to a page in the other farms. Suppose she then builds each farm using a common set of templates. And she then sends spam with the following property. The spam is written from a common template that is, in general, different from that used to write the web pages. Imagine a message R that points to farm X, and a message S that points to farm Y, and that R and S are canonically similar, because they were derived from the same template. Through these and other similarities, the email provider put X and Y into the same cluster. Now the search engine can go directly to X's domains and Y's domains, hashing these web pages, if it has not done so already, and compare them. Whereas, without the email provider's data, it might have no a priori reason to do this comparison.

Consider now what countermeasures the spammer/link farmer might take. She could use more templates for her spam messages or reduce the frequency of these messages. Or she could use more templates to build her web sites. More templates of either type increase her cost. Reducing the message frequencies can reduce her income.

In both these cases of exchanging more structured information, the key idea is to use information from an external ECM space to improve the efficacy of the methods in the ECM space that we are primarily dealing with. The phenomena (including but not limited to spammers and link farms) might expose information about itself in a secondary ECM space. If so, we use that information against it back in the primary ECM space.

It is also possible for the email provider and a search engine to exchange hashes. From the email provider, these could be found from messages pointing to domains in spam clusters. From the search engine, these could be found from web pages in the link farms. This may be useful, because if a link farmer has written several web pages that point to a domain that she has been paid to raise in search rankings, she might be tempted to use portions of the text in spam email.

If hashes are exchanged, they can be sent as a flat list, or with internal structure. Obviously, they can be grouped by clusters that they belong to. This can be done either as clusters in domain space or hash space. Suppose we are a search engine. For clusters in domain space, you can start with a cluster of domains that constitute a link farm, for every link farm. Then, in each domain cluster, make a set of hash clusters ['1745]. Thus send this information to the email provider. Or you can aggregate all the hashes from web pages across all the link farms, and make hash clusters and send those to the email provider. Suppose we are now an email provider. We can take each spam domain cluster, and find the set of hash clusters corresponding to it, and send these. Or we can aggregate all the spam domains, make hash clusters and send these.

Now consider what happens when an email provider or search engine gets this list. Suppose we are an email provider. There are many possibilities, including but not limited to the examples we furnish here. These examples are not exclusive. One or more of these could be done.
1. We can choose to block messages containing m or more hashes, where we choose m by some criteria.
2. We can find the messages containing m or more hashes, and extract the link domains in these, if any. Then add these domains to our RBL.
3. Suppose the list we get has domain cluster information. We can start with the domain clusters as seeds to our domain cluster determination. Then we can search our data for messages with those hashes. From these, we extract the domain links and add these to our domain clusters that the hashes came from. So we use both the imported domain clusters and the hashes associated with these to grow our domain clusters.

Suppose now we are a search engine and we have obtained a list from an email provider. There are many possibilities, including but not limited to the examples we furnish here. These examples are not exclusive. One or more of these could be done.
1. Suppose the list is grouped by domain clusters, and then by the contained hash clusters. We can go to the domains and hash the web pages found there. Then we compare these hashes to those from the email provider. If “enough” are the same, we may choose to regard this as an indicator of a possible link farm, given that the email provider has told us that we have a spammer. Here, “enough” is defined by us according to some external criteria.
2. We might hash pages in our database and compare these to the imported hashes. We can use matches as pointers to web pages that we scrutinize further as possibly being in a link farm.

Both sides might also exchange other information derived from their data. These include, but are not limited to, the topics associated with a domain. These topics might be arbitrarily detailed. We show one possible use of this in the following example. Suppose the search engine has found what it considers are spam domains. Suppose a particular spam domain, e.g. bad356.com, had web pages dealings solely with health supplements. The other side gets this information. Perhaps its members do want such messages. So it decides not to block bad356.com. Or, if individual members can set their preferences, then it might have a policy that if a member wants health supplement messages, then messages from bad356.com will go to that member, but otherwise, these messages will be blocked. The point here is that if one side can offer a classification of the domains, then the other side might choose to use it in some fashion. Notice that the recipient side does not have to apply some type of semantic analysis on its messages to try to discern their topics. (Though of course it can choose to do so.) Rather, it leverages off conclusions derived by the other side.

As a more elaborate example, one side can offer a statistical profile of its spam domains. It might show for a given domain, what topics are associated with it, not just the one in the previous example. Plus, it is possible to find a distribution of “styles” for messages or web pages from a domain. ['0046] For example, what percentage of these have invisible text? The side offering this information may have used some or all of this information in reaching its conclusions as to what it considers spam domains. But the information lets the recipient possibly draw separate conclusions, if it has different criteria as to what constitutes spam to its members.

As another example, suppose one side found that bad356.com was involved with health supplements, finance (e.g. mortgage refinancing) and computer supplies (e.g. toner cartridges). Each of these is a valid business. But how many businesses actually involve all three? The recipient might conclude that bad356.com is spammer, primarily on this basis.

The analysis that the recipient does on the data from another ECM space may be manual, algorithmic or a combination of the two.

We do not claim that this is foolproof. But it can be used in an analogous way to the feedback ratings in eBay or Amazon, as a guide to the user. Thus, in one ECM space, a group can decide to use the conclusions derived by a community in another ECM space.

We now also have a method to produce a graphic analysis that spans the email and link spaces. It builds on, but goes beyond, the graphical clustering in ['1745]. For example, suppose we are looking at domains in these two spaces. We combine the cluster data from these spaces. Then we make new clusters. In these, two nodes A and B (which are domains), can be connected by two types of arcs. Firstly, an undirected arc, which comes from the email, and represents messages that point to both nodes. Secondly, directed arcs. There could be one or two of these, one from A to B, and one from B to A. These are from the web site analysis. An arc from A to B means that a web page on A points to one on B. Hence we can make new clusters, each of which would contain clusters found in the separate spaces.

This method lets an investigator, for either the email provider or the search engine, quickly view and analyze the data, in a way that transcends the earlier limited views that were restricted to a given ECM space. It is useful in at least two different ways. Firstly, by being able to construct clusters with more elements, it lets us more easily block against these, in each ECM space. Secondly, by offering the ability to see more types of connections between two connected elements, we get a more detailed view of the activities or capabilities of those elements and the persons or organization behind them.

If the email provider and the search engine are different organizations, it is also possible that instead of a data exchange, we have a one way flow of data. The recipient might offer other compensation in lieu of its spam domains or link farm domains. Or, the provider might even offer its data for free. Maybe just to have its opponent attacked in a different ECM.

Above, we have discussed the case for one email provider. There is an important other case. There could be a group of email users, whose email is obtained via several email providers, connected in a peer-to-peer (P2P) network. This group could arise because of a commonality of shared interests, professional or recreational. Or, it could be chosen by some means outside this discussion. The group might exist indefinitely, or for some temporary time interval. Members of the group may apply our methods to aggregate hashes of their messages and thence find clusters of these and domain clusters. The group, or members of the group, could then exchange this with a search engine. (Or perhaps the data transfer could be one way.) If so, our statements above apply to this situation.

Currently, a group of users who span several email providers cannot do this. But there is no fundamental technical reason why this cannot be possible in future.

6.3. Exchanging Flat Lists (Between Email and IM-Like ECMs)

- - -

We now turn to another example. Consider an email provider and an IM-like ECM space. Increasingly in the latter, there are robots (automated programs) that send unsolicited, bulk messages to users in that space. This has been aggravated by the increasing ability of IM-like programs to display hypertext that may include images. This hypertext may be HTML, or any language (including any not yet written) that has the ability to show hyperlinks, which are selectable links to other locations in that space or in another ECM space, or to invoke programs that let the user take part in other electronic communication.

As an example of the latter, imagine that you are using IM and you get a message from a robot. It lets you click on a link that brings up a program offering cheap international phone calls. The program might already exist on your computer, or the link may download it to your computer and then run it. The phone connection might be via Voice Over IP (VOIP) or some other such method. (Presumably the program might have a means for you to pay for the call.) Such an ability within IM might not currently exist. But there are no fundamental technological obstacles to it.

The problems of IM-like spam (sometimes called “spim”) and email spam are very similar. If the IM-like spam often has messages with links to websites, then an RBL can found by various means. The use of an RBL in IM-like space has no essential difference with the use of an RBL in email space.

Imagine now an email provider and an IM-like provider. Both generate RBLs from their data. Each might benefit by adding the RBL from the other to its RBL. Conceptually, it would be as though two email providers decided to extend the scope of their RBLs by using the union of the RBLs. How each party generates an RBL is left unspecified.

But, if either side were to use our methods to find an RBL, it would have advantages to the other side that receives this RBL, including but not limited to the following:
1. From its data, it can generate an RBL frequently, say daily or even at shorter intervals. This compares favorably with the search engine obtaining an RBL from a central site, like Spamhaus. Such sites can update their RBLs hourly, say, but that is not the throughput. That is, the time between when a possible spam domain is submitted to the site and when the site adds that domain to its publicly available RBL can be much longer, days or even weeks. There are several reasons. Such central sites must guard against false information being fed to them, to discredit their lists. So they often perform manual checking on submissions. Which takes time. Or they might also require that several or more parties send them the same domain, as extra confirmation that the domain is a spammer. This also takes time. Plus, there is also the earlier length of time that it takes an email provider to come to a conclusion that a domain is a spammer. This length of time needs to be added to the time that a central RBL site will take to process that submission and presumably approve it and publish it. Whereas if it uses our methods, in an automatic mode, it should be able to offer a list of bulk domains far faster.
2. The bulk domains are the ones pertinent to the email provider's situation. These are the domains sending it the most bulk mail. An RBL from a central site may have domains that are simply not seen by the provider. If the RBL website has global scope, like Spamhaus, then it may list domains that send spam mostly to other parts of the world. This assumes that the email provider has a limited geographic scope.
3. But suppose the email provider has global scope. It is still possible that the bulk domains seen by it are not necessarily those seen by others.
4. The number of bulk domains generated may easily be greater than those offered by a central RBL website that just does primarily manual assessment of domains.
5. The bulk domains generated are fresh. That is, they can be derived from very recent data, possibly within the last 24 hours or less. Presumably, these domains are currently active. So the recipient has the option of deleting from its lists, domains which have not been appearing, in RBLs sent from one side using our methods, for some specified time that the search engine gets to set.
6. We recommend that the order of entries in the RBL be in terms of decreasing frequency of messages corresponding to an entry. That is, the first entry is the domain that most messages point to, the second entry is the second most frequent bulk domain, etc. If the RBL is presented in such a way to the other side (as opposed to, e.g. alphabetical order), then this has utility to that side. It tells which are the most frequent issuers of bulk messages. The other side might use this for a more efficient hunt for spammers. Of course, there is no intrinsic difference between this ordering and an ordering based on increasing frequency of messages. The other side just needs to know that the list is ordered, and in ascending or descending frequency.
7. The methods are objective, assuming that it does not add entries to its list based on a manual assessment of those entries. What this means is that the recipient can regard the list as unaffected by any possible subjective assessment by personnel at the originating side.
8. A variation on the previous point is for it to offer two lists. The first is found by our methods. The second consists of extra domains that have been manually assessed as definitely spammers, according to some criteria. If the recipient regards it as reliable in its subjective assessments, then the recipient could use both lists.

The motivation in example 1 was to attack spammers on two fronts, in email and in searching. Likewise, here, we attack spammers in email and in IM-like spaces. Because an IM-like spammer who sends spam pointing to the spammer's websites may also issue email spam pointing to those websites, as an extra revenue source. Our method here attacks this business model.

Both sides might also exchange information regarding the times at which messages were received.

If the email provider and the IM-like provider are different organizations, it is also possible that instead of a data exchange, we have a one way flow of data. The recipient might offer other compensation in lieu of its spam domains. Or, the provider might even offer its data for free. Maybe just to have its opponent attacked in a different ECM.

Above, we have discussed the case for one email provider and one IM-like provider. There are several other cases possible.

On the email side, there could be a group of email users, whose email is obtained via several email providers, connected in a p2p network. This group could arise because of a commonality of shared interests, professional or recreational. Or, it could be chosen by some means outside this discussion. The group might exist indefinitely, or for some temporary time interval. Members of the group may apply our methods to aggregate hashes of their messages and thence find clusters of these and spam domains and make an RBL. The group, or members of the group, could then exchange this with the IM-like side. (Or perhaps the data transfer could be one way.) If so, our statements above apply to this situation.

On the IM-like side, there could be a group of IM-like users, whose messages are obtained via several IM-like providers, connected in a p2p network. This group could arise because of a commonality of shared interests, professional or recreational. Or, it could be chosen by some means outside this discussion. The group might exist indefinitely, or for some temporary time interval. Members of the group may apply our methods to aggregate hashes of their messages and thence find clusters of these and spam domains and make an RBL. The group, or members of the group, could then exchange this with the email side. (Or perhaps the data transfer could be one way.) If so, our statements above apply to this situation.

6.4. Exchanging More Structured Information (Between Email and IM-Like ECMs)

- - -

Just as we went from example 1 to example 2, for email and search engines, we can extend the scope of example 3. An email provider and an IM-like provider can exchange cluster information. Each can use the clusters provided by the other as external information to seed the cluster computations of ['1745] in its ECM space. This offers the ability to improve the efficacy of the methods applied only to data within its space.

Likewise, they could exchange hashes and use these in ways identical or similar to those discussed in example 2.

Both sides might also exchange other information derived from their data. These include, but are not limited to, the topics associated with a domain. These topics might be arbitrarily detailed. We show one possible use of this in the following example. Suppose one side has found what it considers are spam domains. Suppose a particular spam domain, e.g. bad356.com, was found to be involved with health supplements. The other side gets this information. Perhaps its members do want such messages. So it decides not to block bad356.com. Or, if individual members can set their preferences, then it might have a policy that if a member wants health supplement messages, then messages from bad356.com will go to that member, but otherwise, these messages will be blocked. The point here is that if one side can offer a classification of the domains, then the other side might choose to use it in some fashion. Notice that the recipient side does not have to apply some type of semantic analysis on its messages to try to discern their topics. (Though of course it can choose to do so.) Rather, it leverages off conclusions derived by the other side.

As a more elaborate example, one side can offer a statistical profile of its spam domains. It might show for a given domain, what topics are associated with it, not just the one in the previous example. Plus, it is possible to find a distribution of styles for messages from a domain. ['0046] For example, what percentage of these have invisible text? The side offering this information may have used some or all of this information in reaching its conclusions as to what it considers spam domains. But the information lets the recipient possibly draw separate conclusions, if it has different criteria as to what constitutes spam to its members.

As another example, suppose one side found that bad356.com was involved with health supplements, finance (e.g. mortgage refinancing) and computer supplies (e.g. toner cartridges). Each of these is a valid business. But how many businesses actually involve all three? The recipient might conclude that bad356.com is spammer, primarily on this basis.

We do not claim that this is foolproof. But it can be used in an analogous way to the feedback ratings in eBay or Amazon, as a guide to the user. Thus, in one ECM space, a group can decide to use the conclusions derived by a community in another ECM space.

Another type of information that might be associated with a domain is various timing data. These include, but are not limited to, the start and end times recorded at the provider, for messages that were received for that domain.

Also of possibly utility is the maximum number of messages received per some time interval, for messages pointing to that domain. The idea here is that spam in email or IM-like contexts might come in pulses. One possible reason is that some spammers find a node on the network through which they can inject a lot of messages. This may have to be done in a short time, before antispam techniques on that node or external to the node detect the high volume and act to prevent further bulk submission from the node. So the message provider can include such information about one or more domains in data that it sends to the message provider in the other ECM space. The recipient provider might have its own policies about, say, a minimum threshold rate, above which, it might consider the associated domain as a spammer.

We now also have a method to produce a graphic analysis that spans the email and IM-like spaces. It builds on, but goes beyond, the graphical clustering in ['1745]. For example, suppose we are looking at domains in these two spaces. We combine the cluster data from these spaces. Then we make new clusters. In these, two nodes A and B (which are domains), can be connected by one or two arcs. Firstly, an undirected arc which comes from the email, and represents email messages that point to both nodes. Secondly, an undirected arc which comes from the IM-like data, and represents IM-like messages that point to both nodes. Hence we can make new clusters, each of which would contain clusters found in the separate spaces.

This method lets an investigator, for either the email provider or the IM-like provider, quickly view and analyze the data, in a way that transcends the earlier limited views that were restricted to a given ECM space. It is useful in at least two different ways. Firstly, by being able to construct clusters with more elements, it lets us more easily block against these, in each ECM space. Secondly, by offering the ability to see more types of connections between two connected elements, we get a more detailed view of the activities or capabilities of those elements and the persons or organization behind them.

If the email provider and the IM-like provider are different organizations, it is also possible that instead of a data exchange, we have a one way flow of data. The recipient might offer other compensation in lieu of its spam domains. Or, the provider might even offer its data for free. Maybe just to have its opponent attacked in a different ECM.

On the email side, there could be a group of email users, whose email is obtained via several email providers, connected in a p2p network. This group could arise because of a commonality of shared interests, professional or recreational. Or, it could be chosen by some means outside this discussion. The group might exist indefinitely, or for some temporary time interval. Members of the group may apply our methods to aggregate hashes of their messages and thence find clusters of these and domain clusters. The group, or members of the group, could then exchange this with the IM-like side. (Or perhaps the data transfer could be one way.) If so, our statements above apply to this situation.

On the IM-like side, there could be a group of IM-like users, whose messages are obtained via several IM-like providers, connected in a p2p network. This group could arise because of a commonality of shared interests, professional or recreational. Or, it could be chosen by some means outside this discussion. The group might exist indefinitely, or for some temporary time interval. Members of the group may apply our methods to aggregate hashes of their messages and thence find clusters of these and domain clusters. The group, or members of the group, could then exchange this with the email side. (Or perhaps the data transfer could be one way.) If so, our statements above apply to this situation.

6.5. Exchanging Flat Lists (Between Email, Search and IM-Like ECMs)

- - -

A straightforward generalization of examples 1 and 3. An email provider, a search engine and an IM-like provider might decide to pool their RBLs into one RBL and use it for greater efficacy.

The email side might be a P2P network spanning several email providers. The email side also includes email-like providers like those for blogs, bulletin boards and newsgroups.

The IM-like side might be a P2P network spanning several IM-like providers.

Strictly, none of these parties need use our methods to make their RBLs. But there are advantages to their partners if they do so, and these advantages have been described earlier.

6.6. Exchanging More Structured Information (Between Email, Search and IM-Like ECMs)

- - -

A straightforward generalization of examples 2 and 4. An email provider, a search engine and an IM-like provider might decide to exchange cluster information for greater efficacy.

Likewise, they could exchange hashes and use them in ways identical or similar to those discussed in example 2.

The graphic ability here extends those described earlier. Now, in a common graph, we can make and show a cluster spanning all these spaces. Nodes can be connected if relationships exist in any of the spaces.

This method lets an investigator, quickly view and analyze the data, in a way that transcends the earlier limited views that were restricted to a given ECM space, or to two ECM spaces. It is useful in at least two different ways. Firstly, by being able to construct clusters with more elements, it lets us more easily block against these, in each ECM space. Secondly, by offering the ability to see more types of connections between two connected elements, we get a more detailed view of the activities or capabilities of those elements and the persons or organization behind them.

The email side might be a P2P network spanning several email providers. The email side also includes email-like providers like those for blogs, bulletin boards and newsgroups.

The IM-like side might be a P2P network spanning several IM-like providers.

6.7. Exchanging Between a Link Service and a Non-Link Service

- - -

Web Services are still in their infancy. They have been heavily promoted by Microsoft, IBM, HP, Sun Microsystems and others. Suppose a Web Service, or any other program, has the following characteristics. It accepts a structured message via electronic communication. This will probably be in XML format, though our methods are not restricted to this. It performs some computation on this, which might involve aggregating information from other messages or databases, and maybe it returns a result to the sender and/or it stores the message, possibly modifying it in some fashion, or it forwards the message to some other location on a network, again possibly modifying it before doing so. Furthermore, the incoming message has links to locations on a computer network.

We call such a Web Service or any other program that satisfies the above, a Link Service.

Next, we ask who or what can submit this message to the Link Service? In general, Link Services are meant to be used primarily by programs, not manually. So what can send to this Link Service? We expect that typically, any program that can satisfy a possible challenge protocol by the Link Service will be allowed to then send one or more messages. We do not expect that challenge protocol to be a serious difficulty to overcome in most cases, if it even exists. The reason is fundamental. It would be akin to you using a browser and going to a website, and then that website asking for a payment before it even shows you a web page. Or, in the real world, having to pay to receive a flyer containing an ad.

We expect that there will be a subset of Link Services that will offer output to be directly experienced by a human. Perhaps in readable form. Or with audio. Or linked physically into the human neural system. We also include the case where the Link Service will output human viewable data that will be sent to another Link Service or program or location on the network. The essential point is that the data will be eventually experienced by humans, but that the output of this Link Service need not necessarily be so experienced.

In either case, we can expect attempts at unsolicited bulk messaging, given that this has occurred in other types of mass electronic communication. (Junk faxes, email spam, IM/SMS spam.) Link Services will then have an incentive to reduce this unsolicited bulk messaging, which we now define as spam, in accordance to similar phenomena in other electronic communications.

How? If a Link Service does not accept external data from an electronic network, then it might not have this problem. But if it does accept external data, then it faces an analogous problem to that of email providers. For a Link Service to be economically feasible, it is unlikely to be able to have a human manually approve or reject every input message. A small, specialized Link Service may be able to do this. But a high volume Link Service is unlikely to afford this. (The same problem as faced by email providers.) Plus, any high volume Link Service with a large human viewership, will be attractive to spammers, for that very reason.

To combat this, we offer our existing methods. Our canonical steps of ['0046] can be applied, adhering to the principle of reducing a message down to only that which can be physically experienced by a human. We expect that messages will have the means to incorporate hyperlinks, because these are easy to use and people have been conditioned to them via a conventional browser experience. These do not necessarily have to be http-style hyperlinks. Our methods are applicable to any hyperlinking language.

Given the existence of hyperlinks, if Link Service spam exists, it will probably have such links. Thus, we can aggregate those links, via the methods of ['1745], and make clusters. We can then use ['0046, '1745, '1789, '1899] to mark existing and future messages as being spam. The spammers cannot hide those links from our methods, used programmatically. Because the links must be selectable by a human, and when that happens, the software within which this is done (a generalization of a browser, perhaps) must be able to programmatically use that choice and extract a destination from it, to go to across a network. This is similar to how we can currently programmatically extract link domains from email, despite simple obsfucation attempts by spammers.

Taking this a step further, suppose the link space items are Internet domains. The Link Service can then exchange these with email providers (or an email P2P group), search engines or IM-like providers (or an IM-like P2P group). This can be done either as RBL data, or as cluster data.

If the Link Service imports RBL data from another ECM, this data could have been made by unspecified means. Or, by the methods in ['0046, '1745, '1789, '1899]. If the latter is done, it can give greater efficacy, the reasons for which have been explained above.

The criteria by which a Link Service determines which parties in other ECM spaces to partner with is mostly outside the scope of this discussion. But one possibility is that it uses a Ratings Link Service, described below, to validate its partners.

It is also possible that a Link Service spam might have destinations associated with it that are not in hyperlinks. These include the equivalent of sender address on a network and relay information, if such exists, about the steps taken by the message across the network, en route to the Link Service. Of course, if these exist, they may be forged, as can happen with email. But if they can be verified, by some means, then they could be added to the destinations extracted from the links.

If the Link Service and the non-Link Service are different organizations, it is also possible that instead of a data exchange, we have a one way flow of data. The recipient might offer other compensation in lieu of its data. Or, the provider might even offer its data for free. Maybe just to have its opponent attacked in a different ECM.

The non-Link Service might be a P2P group.

6.8. Exchanging Between two or more Link Services

- - -

Obviously, if two or more Link Services experience spam in their space, they can apply our methods to get lists of spam links. They can aggregate these and use the union for greater efficacy in blocking spam.

6.9. Enhanced Blocking Against Relays in Email

- - -

Email has header information which can often be easily forged by the sender. For example, the sender may do this if she is issuing spam, to hide her address and some or all of the relays from which her mail is going through. But who would falsify a header to include a spammer relay? Thus, while we cannot conclude from the absence of spammer domains from the relay information that a message is not spam, we might reasonably decide that the presence of a spammer domain in the relays is highly indicative of spam, and we can block or mark the message as spam.

Our previous Provisionals have shown how from the email data, we can find spammer domains and use these against the relay domains in the above manner. But from the other ECM spaces, the following is possible:
If we get spam domain information from an IM-like provider or an IM-like P2P network, we can apply these against the relays.
If we get link farm information from a search engine, we can apply these against the relays.
If we get spam domain information from a Link Service, we can apply these against the relays.

7. Other Applications

- - -

The present invention comprises the use of styles in a fuzzy logic system, or a neural network, or a Bayesian system or some other system, where the intent may be, in part, to identify bulk messages or spam. This other system may use other input, including, but not limited to, the original messages.

The present invention comprises the use of styles in conjunction with a human language dependent system, where the intent may be, in part, to identify bulk messages or spam.

1. A method of defining a style where the body of a message is empty after we apply our canonical steps to it.

2. A method of defining a style where messages that end up in the same Bulk Message Envelope (BME) after we apply our canonical steps have different sender fields.

3. A method of defining a style where messages that end up in the same BME after we apply our canonical steps have different Subject fields.

4. A method of defining a style where messages that end up in the same BME after we apply our canonical steps have different destinations (link domains).

5. A method of defining a style where a BME has too many relays, where this number can be chosen by the personnel (e.g. systems administrator) analyzing the messages.

6. A method of defining a style of a BME or set of BMEs that is the fraction or number of the domains that are in a Realtime Blacklist (RBL).

7. A method of defining a style of a BME or set of BMEs that is the fraction or number of the relays that are in an RBL.

8. A method of defining a style of a BME or set of BMEs that is the fraction or number of the domains that are in a table of suspected link farms.

9. A method of defining a style of a BME or set of BMEs that is the fraction or number of the domains that have no home pages.

10. A method of defining a style of a BME or set of BMEs that is the fraction
or number of the users (recipients) that have complained about it, where
here the BME or BMEs are derived from incoming messages.

11. A method of defining a style of a BME or set of BMEs that is the fraction
or number of the hashes that are in a table of known bulk message hashes.
